(19) United States
(12) Patent Application Publication
(10) Pub. No.: US 2024/0408619 A1
(43) Pub. Date: Dec. 12, 2024

(54) System and Method for Centrifuging Using an Anti-Parallel Rotor Attachment

(71) Applicant: Blackfly Investments, LLC, DBA Molecular Testing Labs, Vancouver, WA (US)

(72) Inventors: Isabel Brinck, Vancouver, WA (US); Andrew Chastain, Vancouver, WA (US)

(21) Appl. No.: 18/208,567

(22) Filed: Jun. 12, 2023

(51) Int. Cl. B04B 5/04; B04B 5/12; B04B 7/02

(52) U.S. Cl. CPC B04B 5/0414; B04B 5/12; B04B 7/02; B04B 2007/025

(57) ABSTRACT

A centrifuge having a rotor attachment for preparing a small-format blood collection tube after blood collection for handling and analysis. The rotor attachment may include two or more small-container holding orifices designed to hold each container in a plane that is normal (or near-normal) to an axis of rotation during centrifuging. That is, the angle at which each small-format container is held during a centrifugation procedure is low (e.g., zero or near-zero). Having a rotor attachment that imparts a small angle or near-zero angle during centrifugation results is solutions being separated in layers that are aligned normal to a vertical axis of the small-format container. This separation into layers in the small-format container is more robust during handling and transport as a mid-level gel exhibits strong cohesion to the inner walls of the small-format containers, thereby maintaining separation between red blood cells as collected and a resident serum.

### BACKGROUND

Small-format blood containers (sometimes called Microtainers®) are useful for self-collecting blood into a container to be used in diagnostic medical testing at some later time after collection. These small-format containers typically have a smaller overall size than normal-sized blood collection containers to assist in blood collection through capillary bleeding and facilitating shipping and handling when blood samples are required for remote analysis and diagnostics. That is, a small-format container is easier to send through the mail or using shipping companies due to the smaller size. As such, remote testing and diagnostics are more readily accessible when using small-format containers for blood collection. Additionally, small-format containers are used for self collection of capillary blood which does not require the assistance of a licensed phlebotomist and can be done at home alone.

One format of small-format container is a serum separating tube (SST) which contains a clot activator (silica dioxide particles) and a gel layer. After blood collection, a typical lab procedure would be to place the collection tube into a centrifuge for separating densities of various components in the container (e.g., the red blood cells and the plasma or serum). The density of the gel layer is between the densities of the serum and red blood cells, causing it to form a physical separation between those layers. This separation mitigates the effects of hemolysis (e.g., the destruction of red blood cells) which causes material from inside the red blood cells to contaminate the serum. Having the different blood components fully separated by density (e.g., centrifugation) maintains the integrity of the serum for testing and mitigates additional hemolysis that could occur during transportation of the patient sample. Equipment for proper centrifugation, though, may be difficult to provide in remote (e.g., “at home”) settings. That is, a centrifuge that is capable of generating the rotational force needed to properly separate the blood is typically large, expensive, and uncommon such that consumers using “at-home” collection kits will not have access to a proper centrifuge.

### BRIEF DESCRIPTION OF THE DRAWINGS

Embodiments of the subject matter disclosed herein in accordance with the present disclosure will be described with reference to the drawings, in which:

FIG. 1 is a centrifuge having a rotor attachment having a large fixed-angle holder for one or more small-format blood collection containers;

FIG. 2 is an isometric diagram of a rotor attachment suited to interface with one or more small-format blood collection containers in a centrifuge according to an embodiment of the subject matter disclosed herein;

FIGS. 3A-3D are additional views of the rotor attachment from FIG. 2 suited to interface with a small-format blood container according to an embodiment of the subject matter disclosed herein;

FIG. 4 is a centrifuge having a rotor attachment having a low fixed-angle holder for one or more small-format blood collection containers according to an embodiment of the subject matter disclosed herein; and

FIG. 5 is a block diagram of a system for utilizing the centrifuge of FIG. 4 according to an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the devices described herein may be practiced. These devices may, however, be embodied in many different forms and should not be construed as limited to the embodiments set forth herein; rather, these embodiments are provided so that this disclosure will satisfy the statutory requirements and convey the scope of the subject matter to those skilled in the art.

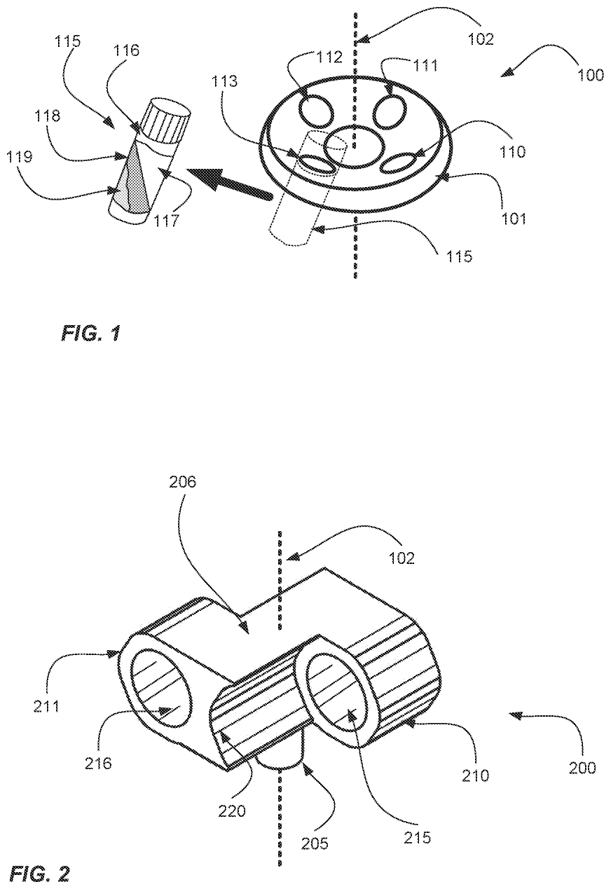

By way of an overview, the systems and devices discussed herein may be directed to a centrifuge having a rotor attachment for preparing a small-format blood collection tube after blood collection for handling and analysis. The rotor attachment may include two or more small-container holding orifices designed to hold each container in a plane that is normal (or near-normal) to an axis of rotation during centrifuging. As discussed above, in the background section, conventional centrifuges may hold small-format containers at a large angle during centrifuging resulting in a separation of solutions therein into different densities along an angle that is parallel to the axis of rotation. That is, the demarcation between layers will be orthogonal to a ray formed between the demarcation plane and the axis of rotation. Such an angle may be too large with respect to the small-format container wherein the solutions tend to mix back together during handling and transport. Having a rotor attachment that imparts a small angle or near-zero angle during centrifugation results is solutions being separated in layers that are aligned normal to a vertical axis of the small-format container. This separation into layers in the small-format container is more robust during handling and transport as a mid-level gel exhibits strong cohesion to the inner walls of the small-format containers, thereby maintaining separation between red blood as collected and a resident serum. These and other aspects of the subject matter disclosed herein are described below with respect to FIGS. 1-5.

FIG. 1 is an isometric diagram of a rotor attachment 100 having a large fixed-angle holder for one or more small-format blood collection containers. In this rotor attachment 100, the circular central member 101 may include four holding spaces 110, 111, 112, and 113 for securing four different small-format containers. As can be seen, the angle at which these four small-format containers are held within the circular central member 101 is quite large with respect to an axis of rotation 102. In this view, this angle (deemed a large angle) is about 45 degrees as can be seen in the position of the phantom small-format container 115 shown in the held position in holding space 113. In a similar manner, three additional small-format containers (not shown) may be secured in the circular central member 101 as well.

As a blood sample is collected into a small-format container, a first helpful step is the preparation of the blood samples. Typically, each container is pre-filled with an amount of additive to assist with a specified procedure. For example, a test for a specific presence of agents may be more keenly elicited through use of a dedicated additive. The small-format container is filled to a specified volume (e.g., shown on container as a fill line) to ensure the proper blood-to-additive ratio. Then, proper procedure may require mixing of all additives with the blood sample in the container by gentle inversion five to ten times immediately after collection. This assists in the clotting process. This also assures homogenous mixing of any additives with the blood sample.

To ensure further success, the container should be centrifuged to cause the serum to be physically separated from contact with red blood cells as soon as possible, typically within 30 minutes from the time of collection. This separation may be accomplished by centrifugation, which is a mechanical process that involves the use of the centrifugal force to separate particles from a solution according to their size, shape, density, and viscosity. As is typical, denser components of the mixture tend to migrate away from the axis of the centrifuge (e.g., axis 102 in FIG. 1), while the less dense components of the mixture migrate towards the axis. This phenomenon typically occurs at rotations speeds that reach a magnitude of 1000 relative centrifugal force (rcf) (often called g-forces in pop culture). RCF is a function of revolution per minute (rpm) as well as distance from the axis 102 of rotation.

This specific rotor attachment 100, however, exhibits problems after centrifuging the mixture inside the small-format container. As can be seen in the side diagram of the container 115, the mixture tends to separate into distinct solutions of different densities with boundaries parallel to the axis of rotation 102. Thus, the red blood cells 119 (which is a denser solution) tends to migrate to a corner portion of the container 115, while a separating gel 118 with a density between the red blood cells 119 and serum 117 tends settle between the higher density red blood cells 119 and the lower density serum 117. Thus, serum 117 that has been collected in the solution with the lowest density and tends to migrate toward the axis of rotation to make way for the denser solutions (the red blood cells 119 and gel 118). As can be seen, these demarcation lines between different density solutions 117, 118, and 119 are not only aligned with the axis of rotation, these solutions 117, 118, and 119 are also largely aligned with a major axis of the container 115 itself. As a result, during transportation, the different density solutions tend to mix back into one homogenous solution again. This, in turn results in increased likelihood of hemolysis (e.g., the destruction of red blood cells) which derives from repeated agitation of the container during transport. Thus, centrifuging small-format containers 117 at a large fixed-angle does not result in a mixture centrifuged in a manner suited to match the container or purpose for which centrifugation is desired.

FIG. 2 is an isometric diagram of a rotor attachment 200 suited to interface with one or more small-format blood collection containers in a centrifuge to hold containers at a small fixed-angle to overcome the problems of the centrifuge of FIG. 1 according to an embodiment of the subject matter disclosed herein. As was evident from the results of centrifuging using the rotor attachment 100 of FIG. 1 with a large fixed-angle, reducing the angle in which the small-format container is held in the centrifuge can mitigate problems with having liquids delineated along a major axis of the small-format container. Thus, the rotor attachment 200 of FIG. 2 includes a first container holding orifice 215 with a surrounding holding member 210 (e.g., a first orifice having a first aperture normal to a first direction) that may be integral with the overall rotor attachment 200 and its additional portions. In this embodiment, additional portions may include a second container holding orifice 216 with a second surrounding holding member 211 (e.g., a second orifice having a second aperture normal to a second direction). In other embodiments (not shown), there may be several more pairs of container-holding orifices surrounded by respective holding members such that several small-format containers (also not shown) may be held in place by the rotor attachment 200. Further, in an effort to provide balance during a centrifugation process, an axis of rotation 102 may be disposed equidistant form every aperture (e.g., the rotor attachment comprises a central rotational axis disposed equidistant between the first and second apertures). The rotor attachment may also comprise a polypropylene material.

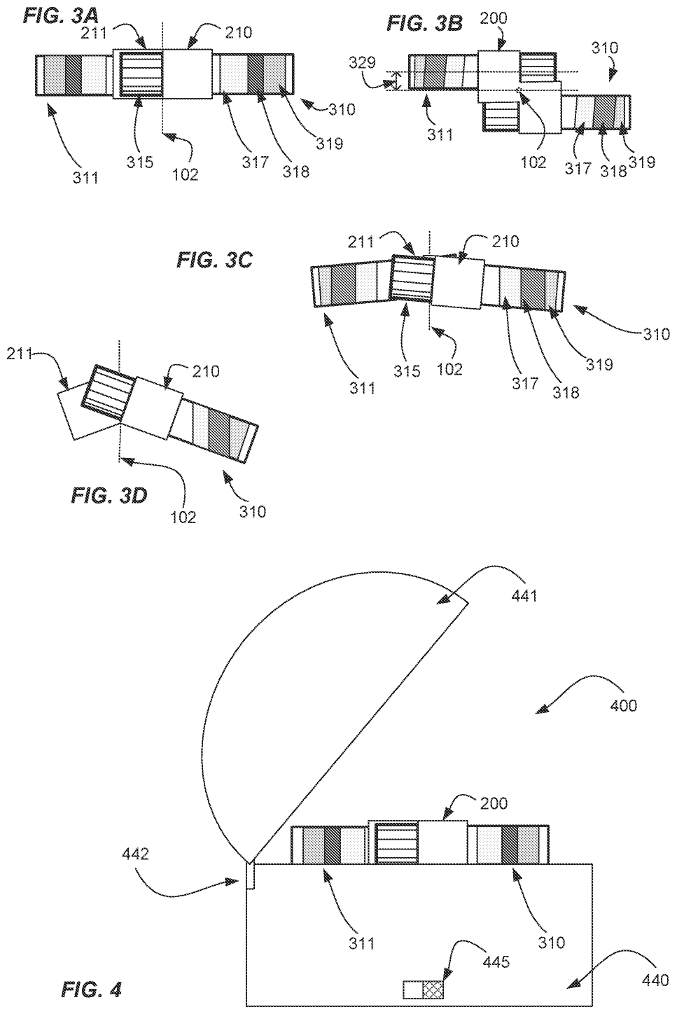

As can be appreciated, the angle at which small-format containers may be held in place in the first container-holding orifice 215 is a low angle or even zero angle (this is illustrated further with respect to FIGS. 3A-3C below). In this sense, a low angle also includes a zero angle. Further, a portion of a central member of the rotor attachment 200 disposed near each container-holding orifice 215 and 216 may also include ridges 220 shaped to match a contour of a lid (not shown) for each small-format container (also not shown in FIG. 2). This matching contour will assist in locking each small-format container into place during centrifugation as ridges in a lid of each small-format container will interface is a motion reducing manner to hold each small-format container in each respective container-holding orifice 215 and 216. Further, the central portion of the rotor attachment 200 may include an interface 205 for attaching to a rotor of a centrifuge motor (not shown) such that the rotor attachment 200 may be rotated about the axis of rotation 102.

FIGS. 3A-3D are additional views of the rotor attachment 200 from FIG. 2 suited to interface with a small-format container according to an embodiment of the subject matter disclosed herein. In a first example embodiment, FIG. 3A shows a rotor attachment having a zero angle (e.g., zero planar deviation) for holding two small-format containers 310 and 311 in respective container holders 210 and 211. As can be seen, each container 310 and 311 is securely held in place with a lid (only lid 315 is shown) held securely by the ridges formed in the rotor attachment (not seen because the lid is in front of them). The first container 310 exhibits a major axis aligned in a first direction and the second container 311 exhibits a major axis aligned in an opposite direction (e.g., 180 degrees away from the first major axis).

In this sense, these two containers 310 and 311 are held secure to the rotor attachment in an anti-parallel manner. Further, one can appreciate the symmetry of how the containers 310 and 311 are held in place so as to exhibit an equal weight balance about the axis of rotation 102. Thus, as each small-format container 310 and 311 may be centrifuged (e.g., rotated about the rotation axis at greater than 1000 rcf), wherein the contents of each small-format container tend to separate based on density. The “heavier” solutions 319 (e.g., denser solutions, in this case the red blood cells 319) migrate to the “bottom” of each container 310 and 311 while the “lighter” solutions 317 (e.g., less-dense solutions, in this case, serum 317) migrate toward the “top” of each container. Therefore, after centrifuging the distribution of density is aligned orthogonal to the axis of rotation 102 and with the rotor attachment holding the small-format container at a zero angle (in FIG. 3A), this is also orthogonal to the major axis of each container 310 and 311. In this manner, having various solutions aligned orthogonal to the major axis of the small-format containers renders each small-format container and its contents in the best condition for transport and undesired agitation.

FIG. 3B is another view of the rotor attachment 200 having two engaged small-format containers 310 and 311 from a top view. Once can see here that the axis of rotation 102 is located at a center point of the rotor attachment 200 and the engaged small format containers 310 and 311 may be centrifuged in a clockwise manner (from this top perspective). As a result, because of the desire to have two small-format containers 310 and 311 engaged in a small space (e.g., small enough to fit into a small-format “mini” centrifuge (discussed below)), the small-format containers 310 and 311 are radially offset from the axis of rotation 102. This is illustrated by the reference numeral 329 and each small-format container 310 and 311 is situated with respect to the rotor attachment 200 such each major axis of each small-format container 310 and 311 is offset by distance 329 (e.g., a radial deviation—as opposed to a planar deviation discussed above with respect to FIG. 3A and below with respect to FIGS. 3C and 3D). Thus, after centrifugation, one can see that the solutions 317, 318, and 319 are not orthogonal to the major axis of the container 311, but rather exhibit a slight lean relative to the radial offset 329. This radial offset does not affect the overall goal of centrifugation as the solutions 317, 318, and 319 remain separated by demarcation boundaries that remain sufficiently close to orthogonal so as to prevent problems associated with handling and agitation after centrifugation.

In a second example embodiment, FIG. 3C shows a rotor attachment having a low angle position for holding two small-format containers 310 and 311 in respective container holders 210 and 211. In this embodiment, the low angle is approximately five degrees from the parallel directions of the major axis of each container 310 and 311. That is, the planar deviation here is five degrees. As can be seen, each container 310 and 311 is securely held in place with a lid (only lid 315 is shown) held securely by the ridges formed in the rotor attachment (not seen because the lid is in front of them). The first container 310 exhibits a major axis aligned in a first direction and the second container 311 exhibits a major axis largely aligned in an opposite direction (e.g., 170 degrees away from the first major axis).

In this sense, these two containers 310 and 311 are held secure to the rotor attachment in a quasi-anti-parallel manner. Further, one can appreciate the symmetry of how the containers 310 and 311 are held in place so as to exhibit an equal weight balance about the axis of rotation 102. Thus, as each small-format container 310 and 311 may be centrifuged (e.g., rotated about the rotation axis at greater than 1000 rcf), wherein the contents of each small-format container tend to separate based on density. The “heavier” solutions 319 (e.g., denser solutions, in this case the red blood cells 319) migrate to the “bottom” of each container 310 and 311 while the “lighter” solutions 317 (e.g., less-dense solutions, in this case, serum 317) migrate toward the “top” of each container. Therefore, after centrifuging the distribution of density is still aligned orthogonal to the axis of rotation 102 and with the rotor attachment holding the small-format container at a five-degree angle (in FIG. 3C), this is also nearly orthogonal to the major axis of each container 310 and 311. In this manner, having various solution aligned nearly orthogonal (within five degrees) to the major axis of the small-format containers renders each small-format container and its contents in the best condition for transport and undesired agitation.

In a third example embodiment, FIG. 3D shows a rotor attachment having another low angle position for holding two small-format containers (only container 310 is shown in FIG. 3D) in respective container holders 210 and 211. In this embodiment, the low angle is approximately ten degrees from the parallel directions of the major axis of each container. That is, the planar deviation here is ten degrees. The first container 310 exhibits a major axis aligned in a first direction and a second container would exhibit a major axis largely aligned in an opposite direction (e.g., 160 degrees away from the first major axis).

In this sense, small-format containers are held secure to the rotor attachment in a quasi-anti-parallel manner. Further, one can appreciate the symmetry of how the containers are held in place so as to exhibit an equal weight balance about the axis of rotation 102. Thus, as each small-format container may be centrifuged (e.g., rotated about the rotation axis at greater than 1000 rcf), wherein the contents of each small-format container tend to separate based on density. The “heavier” solutions (e.g., denser solutions, migrate to the “bottom” of each container 310 and 311 while the “lighter” solutions (e.g., less-dense solutions, migrate toward the “top” of each container). Therefore, after centrifuging the distribution of density is still aligned orthogonal to the axis of rotation 102 and with the rotor attachment holding the small-format container at a ten degree angle (in FIG. 3D), this is also nearly orthogonal to the major axis of each container 310 and 311. In this manner, having various solution aligned nearly orthogonal (within ten degrees) to the major axis of the small-format containers renders each small-format container and its contents in the best condition for transport and undesired agitation.

FIG. 4 is a centrifuge 400 having a rotor attachment 200 having a low fixed-angle holder for one or more small-format blood collection containers 310 and 311 according to an embodiment of the subject matter disclosed herein. The centrifuge 400 of FIG. 4 may be called a mini-centrifuge as it may be intended for home use or non-laboratory use. Thus, the form factor (e.g., overall size) may be fairly small compared to a laboratory-grade centrifuges. Such a small-format centrifuge 400 may be well suited for home use using small-format containers 310 and 311 for “at-home” blood collection. Thus, the anti-parallel rotor attachment 200 of FIG. 2 is well suited to be used in the mini-centrifuge 400 of FIG. 4 so as to hold at least two small-format containers 310 and 311 at a low angle for centrifugation.

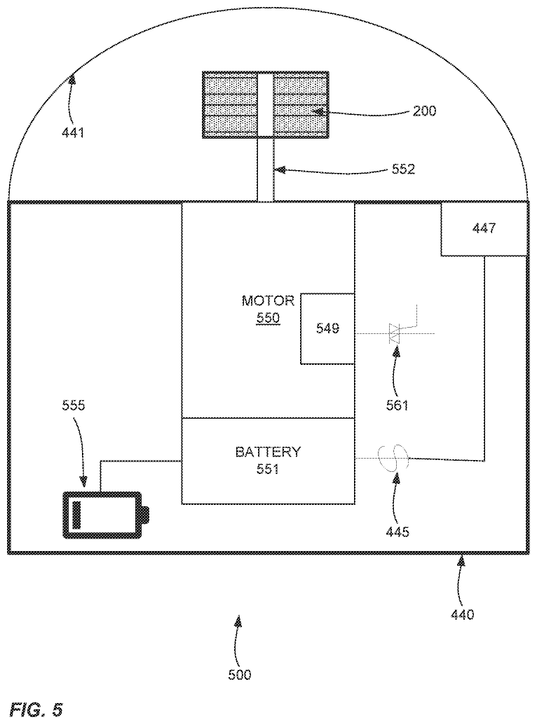

In the embodiment of FIG. 4, the mini-centrifuge 400 includes an encapsulating lid 441 that is attached to a base portion 440 by a rotating hinge 442. The encapsulating lid 441 may be opaque, transparent, or translucent and suited to cover a cavity in which a motor (e.g., an actuator), rotor and rotor attachment 200 are housed. The overall size of the mini-centrifuge 400 may be dependent upon the angle at which containers 310 and 311 are held. That is, with a greater angle (while still being considered a low angle) for the rotor attachment 200 holders, the smaller the overall diameter of the mini-centrifuge 400 may be. Thus, the diameter dimension of the mini-centrifuge 400 (and the corresponding lid 441) are large enough to allow free rotational motion (driven by a motor not shown in FIG. 4) of the rotor attachment 200 engaged with two or more small-format containers 310 and 311. In the embodiment shown in FIG. 4, the base portion 440 may also have an on/off switch 445 for engaging and disengaging rotational centrifugation motion. Additional components of the overall system may also be present as discussed in the block diagram of FIG. 5.

FIG. 5 is a block diagram of a system 500 for utilizing the centrifuge 400 of FIG. 4 according to an embodiment of the subject matter disclosed herein. In this system 500, the centrifuge 400 may include a number of previously discussed components. As such, the centrifuge may include a base 440 that may be hingeably attached to an encapsulating lid 441. The base 440 may house a motor 550 having a rotor 552 that may be rotated when the motor 550 is operating. The motor 550 may be a 3-volt brushless direct current (DC) motor 550. Typical brushless DC motors use one or more permanent magnets in the rotor and electromagnets on the motor housing for the stator. A motor controller 549 converts DC to alternating current (AC). This design is mechanically simpler than that of brushed motors because it eliminates the complication of transferring power from outside the motor to the spinning rotor. The motor controller 549 can sense the rotor's position via Hall effect sensors (not shown) or similar devices and can precisely control the timing, phase, and the like, of the current in rotor coils to optimize torque, conserve power, regulate speed, and even apply some braking. Advantages of brushless motors 550 include long life span, little or no maintenance, and high efficiency. In other embodiments, any other manner of a motor may be realized.

As with any motor 550, rotational motion is imparted to a rotor 552 that may be coupled to the rotor attachment 200 of FIG. 2. Power may be supplied to the motor 550 using a DC source, such as battery 551 (e.g., a power source). The battery 551, which may comprise two AA batteries, in turn, may be recharged using battery charge port 555 and the battery 551 may be engaged or disengaged (e.g., switched on and off) using a battery engagement switch 445 that may, in turn, only be engaged when a lid switch 447 detects that the centrifuge lid 441 is in a closed position. In other embodiments, power may be supplied using an attached transformer coupled to a USB port for supplying DC power to the overall system circuit. Further, the speed of the motor 550 may be adjusted using an optional variable speed motor adjustment 561. In effect, the desired speed of the motor 550 is one that accomplishes the goal of centrifugation wherein 1000 rcf forces may be consistently applied to contents of any engaged small-format container in the rotor attachment 200.

The system 500 of FIG. 5 may typically be part of an overall kit that may be supplied to an “at-home” user to conduct an “at-home” blood test for a specific diagnostic. In one embodiment, such a kit may be suited to test presence of Syphilis using a two-part blood spot. Such a test kit utilizes a sensitive assay that is particularly affected by hemolysis—thus, without proper centrifuging, any blood sample may be too hemolyzed after mailing, handling, and/or repeated agitation. The kit may further include ready-to-go blood collection small-format containers, a means of drawing a blood sample, a funnel for catching a blood sample, and a means for balancing a small-format container and matching funnel upright during blood collection. The kit may further include batteries and/or a USB power cable.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A centrifuge, comprising:
a cavity suited to hold one or more small-format containers;
a rotor attachment having an axis of rotation and configured to hold the one or more small-format containers at a low degree angle relative to a centrifugal plane of motion centered about the axis of rotation;
an actuator coupled to the rotor and configured to rotate the rotor in the centrifugal plane of motion; and
a power source coupled to the actuator and configured to provide power to actuate the rotor.

2. The centrifuge of claim 1, further comprising an encapsulating lid configured to be rotated to encapsulate the cavity.

3. The centrifuge of claim 1, further comprising a base supporting the cavity.

4. The centrifuge of claim 1, wherein low-degree angle comprises approximately zero degrees with respect to an orthogonal direction form the axis of rotation.

5. The centrifuge of claim 1, wherein low-degree angle comprises approximately five degrees with respect to an orthogonal direction form the axis of rotation.

6. The centrifuge of claim 1, wherein low-degree angle comprises approximately ten degrees with respect to an orthogonal direction form the axis of rotation.

7. The centrifuge of claim 1, wherein actuator comprises a 3-Volt DC brushless motor.

8. The centrifuge of claim 1, wherein the base unit comprises an on/off switch configured to control actuation of the actuator.

9. The centrifuge of claim 1, wherein the cavity is sized so as to hold no more than two small-format blood collection containers during centrifugation.

10. The centrifuge of claim 1, wherein rotor attachment is further configured to hold the one or more small-format containers relative to the radial orientation of the centripetal force exerted during rotation.

11. A rotor attachment for a centrifuge, comprising:
a first orifice having a first aperture normal to a first direction, the first aperture sized to allow a small-format container to be inserted;
a second orifice having a second aperture normal to a second direction; the second aperture sized to allow a small-format container to be inserted;
wherein the first and second directional are opposite to each other; and
wherein the rotor attachment comprises a central rotational axis disposed equidistant between the first and second apertures.

12. The rotor attachment of claim 11, further comprising a polypropylene material.

13. The rotor attachment of claim 11, further comprising an interior wall of each aperture shaped to match a contour of a lid of a small-format blood collection container.

14. The rotor attachment of claim 11, further comprising a third orifice having a third aperture normal to a third direction; the third aperture sized to allow a small-format container to be inserted.

15. The rotor attachment of claim 14, further comprising a fourth orifice having a fourth aperture normal to a fourth direction; the fourth aperture sized to allow a small-format container to be inserted.

16. The rotor attachment of claim 11, further comprising a rotor attachment member disposed centrally between the apertures and configured to engage a rotor of a motor.

17. A method of centrifuging red blood, the method comprising:
inserting one or more small format containers into a rotor attachment coupled to an actuator of a centrifuge such that each small-format container is held at a low-angle with respect to an axis of rotation during centrifugation;
actuating the centrifuge; and
separating solutions in each small format container aligned orthogonal to the axis of rotation.

18. The method of claim 17, further comprising actuating the centrifuge to at least 1000 rcf over a period of time.

19. The method of claim 17, further comprising separating the solutions comprises separating solutions according to density wherein a first solution comprises a serum, a second solution comprises a gel and a third solution comprises red blood

20. The method of claim 17, further comprising collecting capillary blood into the one or more small-format containers prior to the inserting.
